(19) United States
(12) Patent Application Publication
(10) Pub. No.: US 2013/0244198 A1
(43) Pub. Date: Sep. 19, 2013

(54) Device for Recording a Bipupillary Axis

(71) Applicants: Karsten Baumann, Keltern (DE); Arno Schöler, Biel/Bienne (CH)

(72) Inventors: Karsten Baumann, Keltern (DE); Arno Schöler, Biel/Bienne (CH)

(21) Appl. No.: 13/772,523

(22) Filed: Feb. 21, 2013

(30) Foreign Application Priority Data
Mar. 14, 2012 (DE) 20 2012 002 640.2

(51) Int. Cl. A61C 19/05

(52) U.S. Cl. CPC A61C 19/05
USPC 433/71

(57) ABSTRACT

A device is disclosed for recording a specific horizontal reference line of a patient that enables the alignment of an upper jaw model to this horizontal reference line. The device serves not only to determine the horizontal reference line with the active communicative aid of the patient but also comprises a bite fork, which can be aligned in accordance with the description and can also be provided by this means. The adjusted bite fork may then be inserted into an articulator and may be fixed in place so that the model of the upper jaw is mounted parallel to the horizontal reference line of the patient.

### RELATED APPLICATIONS

This application claims priority from the German Patent Application DE 20 2012 002 640.2, which was filed on Mar. 14, 2012. That application is incorporated herein by reference as if set out in full.

### BACKGROUND

### FIELD OF THE INVENTION

The present invention relates generally to devices used in the dental engineering industry, and more specifically to a device used to record a patient-specific horizontal reference line.

### DESCRIPTION OF THE RELATED ART

It is known in the field of dental engineering to use the bipupillary axis of the patient as a reference to correctly position the front teeth of the upper jaw. German Patent DE 10 2007 020 675 A1 to Dr. Rainer Schöttl, for example, shows that it is known to use the bipupillary axis to vertically adjust the position of the front teeth. This line is generally defined by a dentist based on the positioning of the center of the patient's irises. While vertical adjustment is possible, horizontal adjustment in the interest of aesthetic improvement is not possible in this and other conventional systems.

The present application addresses this disadvantage and discloses a device that enables the horizontal adjustment of the position of the front upper teeth in the interest of aesthetic improvement. The purpose of this adjustment is to perfect and optimize the proportions of the patient's entire face and to allow the dentist to measure a “horizontal reference line”, which is a patient-specific definition and is more precise than a reference defined by the bipupillary axis.

This problem is solved as per the invention by the characteristic properties of the main claim. Advantageous refinements of the object of the claim are derived from the characteristics of the dependent claims and from the description and drawing appended hereto.

### SUMMARY OF THE INVENTION

The present application discloses a Device for Recording a Horizontal Reference Line. This device minimizes the limitations found in the prior art, to minimize other limitations that will be apparent upon the reading of the specifications. A first embodiment of the device of the present application enables the horizontal adjustment of the position of the front teeth in the interest of aesthetic improvement.

The present application thus discloses a device for recording a patient's specific horizontal reference line that further enables the alignment of an upper jaw model to this horizontal reference line. The disclosed device is used with the active communication of the patient and further comprises a bite fork that can be aligned relative to the horizontal reference line. After such alignment, the bite fork may then be inserted into an articulator and fixed in place such that the upper jaw model is adjusted to be parallel to the horizontal reference line of the patient.

These and other advantages and features of the present invention are described with specificity so as to make the present invention understandable to one of ordinary skill in the art.

### BRIEF DESCRIPTION OF THE DRAWINGS

The foregoing aspects and many of the attendant advantages of the invention will become more readily appreciated as the same becomes better understood by reference to the following detailed description, when taken in conjunction with the accompanying drawings.

In order to enhance the clarity of the drawings and to improve understanding of these various elements and embodiments of the invention, elements in the drawings have not necessarily been drawn to scale. Furthermore, elements that are known to be common and well understood to those in the industry are not depicted in order to provide a clear view of the various embodiments of the invention, thus the drawings are generalized in form in the interest of clarity and conciseness, wherein:

FIG. 1 is a perspective view of a recording device with positioning device, positioning sight, and bite fork in accordance with a first embodiment of the invention; and

FIG. 2 is a perspective view of a recording device wherein the device is fitted onto an articulator.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Finally, many of the steps are presented below in an order intended only as an exemplary embodiment. Unless logically required, no step should be assumed to be required earlier in the process than a later step simply because it is written first in this document.

In the following description these reference numbers will apply: 1. Device, 2. Connecting Rod, 3. Positioning Arm, 4. Positioning Arm End, 5. Positioning Sight Support, 6. Positioning Device, 7. Positioning Sight, 8. Intermediate Element, 9. Connecting Axis, 10. Bite Fork, 11. Transfer Clamp Element, 12. Base Element, and 13. Bite Fork Articulated Joint.

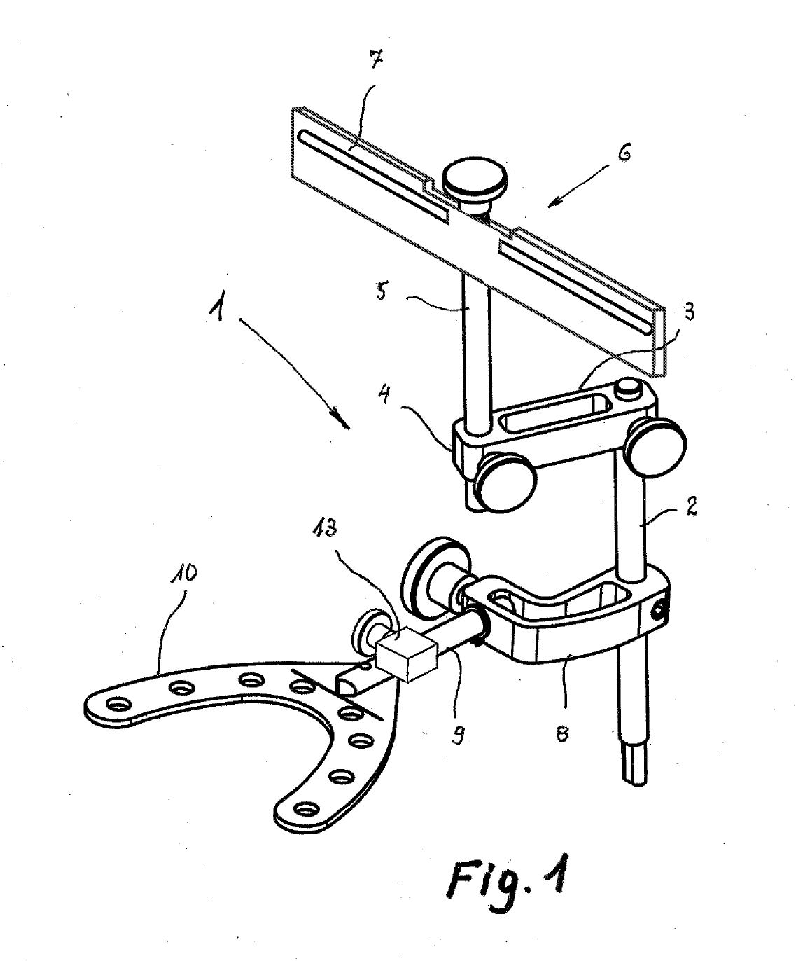

Turning first to FIG. 1, In a first embodiment of the invention, the device 1 comprises a connecting rod 2 which is preferably round in cross section and which stands generally vertically. The device further comprises a positioning arm 3 attached to an upper portion (not labeled) of the connecting rod 2. The positioning arm 3 comprises a positioning arm end 4 into which a positioning device 6 is inserted. The positioning device comprises a rod support 5 that inserts into positioning arm end 4. An upper part of the positioning sight support 5 supports a horizontally positioned positioning sight 7 at a right angle to the positioning sight support 5. The positioning sight support 5 may be moved proximate to a patient's face. The connecting rod 2, positioning arm 3, positioning sight support 5, and positioning sight 7 are preferably made of metal, but in alternative embodiments may be made of any sufficiently strong and rigid material such as but not limited to plastic, composite, and alloy.

Although the positioning sight may be any bar, rod, or generally straight and narrow structure positioned at a right angle to the positioning sight support (and generally aligned with the patient's horizontal reference line), in a preferred embodiment a slot or light gap as shown is utilized. Here the patient may look through the slot or light gap and inform the clinician when it is parallel to his or her horizontal reference line.

This first embodiment of the device further comprises an intermediate element 8 that is fixed to the connecting rod 2 at roughly the center of the connecting rod 2, into which a connecting axis 9 for a bite fork 10 is inserted. The bite fork is rotatable about an axis perpendicular to the connecting rod 2 and perpendicular to the positioning sight 7, and can also be locked in place. The rotation of the bite fork is enabled by an articulated joint 13 that allows the rotation, and also allows the bite fork to be locked in place. In other embodiments the intermediate element may be omitted and the bite fork may be allowed to rotate and be fixed in place by other rotation and locking means as known in the art.

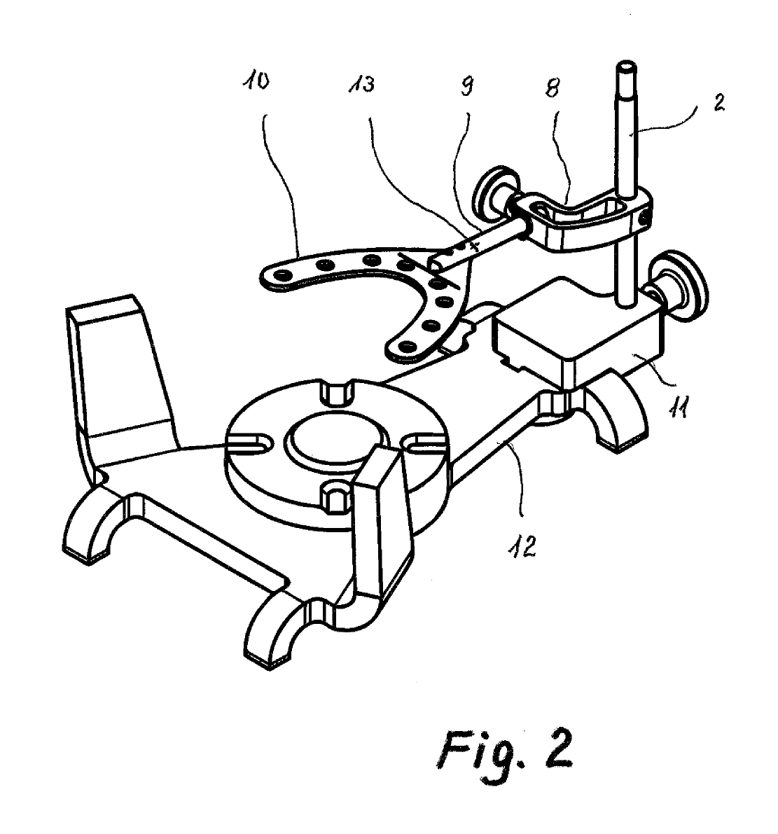

Turning to FIG. 2, a transfer clamp element 11 may be fitted to the bottom end of the connecting rod 2. The transfer clamp is configured to fix the connecting rod 2 with the bite fork 10 but without the positioning device 6 (which may be removed from the connecting rod 2, to the base element 12 of a dental articulator (not shown). This enables the relevant angle of the bite fork 10 relative to the positioning device to be transferred to the articulator.

In operation, positioning sight 7 (preferably comprising a slot or light gap as described above) is first positioned at the focal distance of the patient and fixed in place. In order to determine the patient's horizontal reference line, the patient now tells the person conducting the treatment whether the patient can see that positioning sight 7 has been correctly aligned with their horizontal reference line or in which direction it needs to be adjusted. The person conducting the treatment adjusts the rotary position of the bite fork 10 as needed by means of the connecting axis 9 and uses it to fix the position of the bite fork 10 such that the positioning sight is parallel to the horizontal reference line. In use the device may be supported or mounted to a stationary object, or may be supported by the bite plate, which the patient bites down on; after a self-curing plastically compound material may be applied on the upper surface of the bite fork to assure a stable fixation of the upper jaw on the bite fork

The positioning arm 3 and the positioning device 6 are then removed from the connecting rod 2 and the connecting rod 2 with the now fixed bite fork 10 is then placed onto an articulator using the base element 12 and transfer clamp element 11. A plaster-cast model of the patient's upper jaw may now be positioned and fixed in place. Because of the alignment of the bite fork and the horizontal reference line (achieved in the steps outline above), the upper part of the articulator is now parallel with the bipupillary line of the patient. This provides the dental technician with the means to use the obtained articulator architecture as a guide when subsequently conducting dental restoration. Through this invention, the patient is able to define the horizontal reference line independently from the position of the head and is able to do this with even just one eye.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A device for determining a patient's horizontal reference line and aligning a model of the patient's upper jaw with this horizontal reference line, the device comprising:
a. a positioning device comprising a bite fork and a height-adjustable, horizontal positioning sight, whereby the horizontal reference line may be determined using the positioning device by communicating with the patient.

2. The device of claim 1, wherein:
a. the distance between the positioning sight and the patient's face is adjustable.

3. The device of claim 1 wherein:
a. a rotation angle of the bite fork relative to the positioning sight may be adjusted and fixed in place.

4. The device of claim 3 wherein the bite fork supports the positioning sight when the device is in use.

5. The device of claim 3 wherein the bite fork may be fixed in place and attached to an articulator.

6. The device of claim 3, wherein:
a. the patient's horizontal reference line may be determined by communication with the patient and adjusting the rotation angle of the bite fork relative to the positioning sight.

7. The device of claim 6 wherein:
a. the rotation angle of the bite fork relative to the positioning sight is approximately equivalent to an angle of the bite fork relative to the patient's horizontal reference line.

8. The device of claim 6 wherein the bite fork supports the positioning sight when the device is in use.

9. The device of claim 2 wherein:
a. a rotation angle of the bite fork relative to the positioning sight may be adjusted and fixed in place.

10. The device of claim 9 wherein the bite fork supports the positioning sight when the device is in use.

11. The device of claim 9 wherein the bite fork may be fixed in place and attached to an articulator.

12. The device of claim 9, wherein:
a. the patient's horizontal reference line may be determined by communication with the patient and adjusting the rotation angle of the bite fork relative to the positioning sight.

13. The device of claim 12 wherein:
a. the rotation angle of the bite fork relative to the positioning sight is approximately equivalent to an angle of the bite fork relative to the patient's horizontal reference line.

14. The device of claim 12 wherein the bite fork supports the positioning sight when the device is in use.

15. A method of determining a patient's horizontal reference line, the method comprising the steps of:
a. providing a patient having a horizontal reference line;
b. providing a device comprising:
i. a positioning device comprising a height-adjustable, horizontal positioning sight wherein the distance between the positioning sight and the patient's face is adjustable;
ii. a bite fork configured such that the rotation angle of the bite fork relative to the positioning sight may be adjusted and fixed in place;
c. communicating with the patient and adjusting the rotation angle of the bite fork relative to the positioning sight such that the positioning sight is parallel with the patient's horizontal reference line; and
d. fixing the rotation angle of the bite fork relative to the positioning sight.

16. The method of claim 15 further comprising the steps of:
a. attaching the now fixed bite fork to an articulator.

17. The method of claim 15 further comprising the step of:
a. positioning the positioning sight at a focal distance of the patient.

18. The method of claim 15 wherein the patient supports the device by biting the bite fork.
